(19) United States
(12) Patent Application Publication
(10) Pub. No.: US 2009/0107018 A1
(43) Pub. Date: Apr. 30, 2009

(54) SYSTEMS AND METHODS FOR DISPLAY OR COLLECTION OF DECORATIVE ACCESSORIES

(76) Inventors: Richard Schmelzer, Boulder, CO (US); Sheri Schmelzer, Boulder, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 12/199,634

(22) Filed: Aug. 27, 2008

Related U.S. Application Data
(60) Provisional application No. 60/968,279, filed on Aug. 27, 2007.

(51) Int. Cl. G09F 19/00

(52) U.S. Cl. 40/1

(57) ABSTRACT

A system for securing a decorative accessory. The system includes a display board including an upper surface, a lower surface, and at least one hole. The system includes at least one grommet configured to be inserted in the at least one hole and to receive a decorative accessory. The at least one grommet includes a center portion, a grommet hole, and first and second ends. The first and second ends are configured to engage the upper and lower surfaces, respectively, of the display board upon insertion of the at least one grommet in the at least one hole. The grommet hole is configured to receive the decorative accessory, the decorative accessory having at least one dimension larger than the grommet hole when the grommet hole is in an unexpanded state.

### CROSS REFERENCE TO RELATED APPLICATIONS

The present application claims the benefit of U.S. Provisional Patent application No. 60/968,279, filed on Aug. 27, 2007, the entire contents of which are incorporated herein by reference.

### TECHNICAL FIELD

Embodiments of the present invention relate generally to decorative accessories, and more specifically to systems and methods for collection or display of decorative accessories.

### BACKGROUND

Decorative accessories, such as those configured for insertion through holes in foam footwear or other clothing or related items, continue to gain in popularity. As consumers continue to collect more and more decorative accessories, their collections often exceed the amount of space available for wearing the decorative accessories at any given time. Thus, their excess collection of decorative accessories is often amassed in bags and/or boxes for storage. Furthermore, consumers who assemble collections of decorative accessories often display and/or collect them in bags and/or boxes, similarly to how retailers often display the accessories for sale.

### SUMMARY OF THE INVENTION

Embodiments of the present invention include a system for securing a decorative accessory. The system includes a display board including an upper surface, a lower surface, and at least one hole. The system includes at least one grommet configured to be inserted in the at least one hole and to receive a decorative accessory. The at least one grommet includes a center portion, a grommet hole, and first and second ends. The first and second ends are configured to engage the upper and lower surfaces, respectively, of the display board upon insertion of the at least one grommet in the at least one hole. The grommet hole is configured to receive the decorative accessory, the decorative accessory having at least one dimension larger than the grommet hole when the grommet hole is in an unexpanded state.

### BRIEF DESCRIPTION OF THE DRAWINGS

FIG. 1 illustrates an example display board having grommets, according to embodiments of the present invention; and

FIG. 2 illustrates an enlarged view of a grommet hole assembly.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

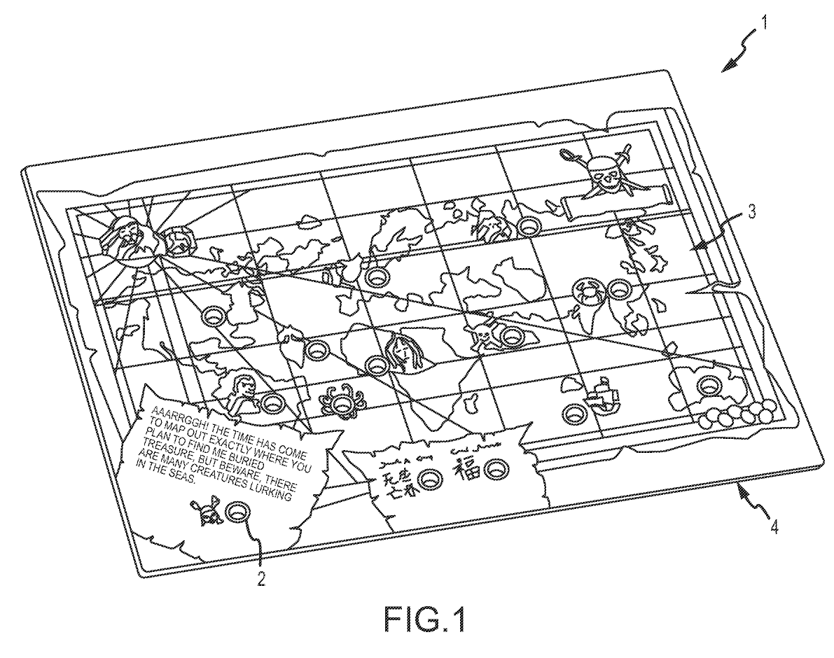

FIG. 1 depicts a collection and/or display board 1 according to embodiments of the present invention. The display board 1 includes an upper surface 3 and a lower surface 4 located below the upper surface 3. Depending on how board 1 is displayed, upper surface 3 may be a front surface, and lower surface 4 may be a back surface, for example. The board includes a four-color, offset graphic applied to wrapped, one-eighth inch thick chip-board, according to embodiments of the present invention. One or more holes may be punched through the board, and grommets such as those depicted in FIG. 1 may be snapped or otherwise inserted into the one or more holes, according to embodiments of the present invention. For example, the display board 1 includes a grommet hole assembly 2 consisting of a grommet inserted into a hole formed in the display board 1. In embodiments, the holes in the display board 1 are expandable.

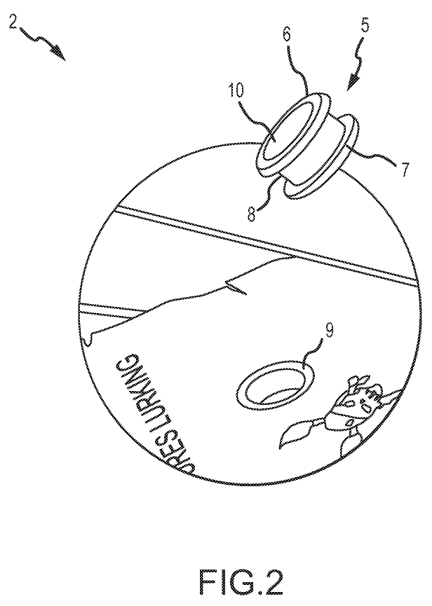

FIG. 2 illustrates an enlarged view of a grommet hole assembly 2. In embodiments, the grommet hole assembly 2 includes a grommet 5 and a hole 9 formed in the display board 1 (see FIG. 1). In embodiments, the grommet 5 includes a center portion 8 with ends 6 and 7 located on either side of the center portion 5. The grommet 5 further includes a grommet hole 10. In embodiments, the grommet hole 10 is expandable such that the grommet hole 10 expands to the size of an object inserted in the grommet hole 10. In embodiments, the ends 6 and 7 extend beyond the center portion such that when the grommet 5 is inserted into the hole 9, the ends 5 and 7 engage the upper 3 and lower 4 surfaces, respectively, of the display board 1 (see FIG. 1). In other embodiments, the diameter of the center portion 8 is sized such that when the grommet 5 is inserted into hole 9, the center portion 8 engages an inner surface of the hole 9. In yet other embodiments, the grommet 5 is configured to snap into hole 9. In embodiments, the grommet 5 is made of rubber or any other desired expandable material.

In embodiments, the grommets may be configured to accept and retain decorative accessories such as the Jibbitz® brand decorative accessories, which may be configured for insertion through an expandable hole, such as, for example, an expandable hole in a piece of resin molded footwear or other article. As an example, referring to FIG. 2, a decorative accessory is inserted into the grommet hole 10 of the grommet 5. The decorative accessories for insertion through the grommets according to embodiments of the present invention may be similar to system 200 as described in U.S. patent application Ser. No. 11/408,130, filed on Apr. 20, 2006, entitled, “System and Method for Securing Accessories to Clothing,” published on Jan. 11, 2007 under U.S. Patent Application Publication No. 2007/0006502, which is incorporated by reference herein in its entirety for all purposes.

According to embodiments of the present invention, means other than grommets may be used to create one or more expandable holes in a display board. For example, a sheet of resin molded or rubber material or the like may be formed with one or more holes, and paper and/or cardboard sheets (with corresponding cutout holes) may be placed on top and/or underneath the sheet, according to embodiments of the present invention. The board may be an eight and one-half by eleven inch size, or other standard size, according to embodiments of the present invention. The board may be hung on a wall and/or may be displayed upright or laying on a surface, similar to picture frames, according to embodiments of the present invention.

According to embodiments of the present invention, a graphic design may be applied to the board in order to encourage collection of a particular kind of decorative accessory. For example, a pirate-themed graphic may be applied to the board for collection and/or display of pirate-themed decorative accessories. According to some embodiments of the present invention, one or more holes may include a graphic indication of a particular decorative accessory intended for insertion in the hole; for example, a hole intended to accommodate a pirate ship decorative accessory may include a graphic depiction of a pirate ship and/or of the particular decorative accessory. The board may be sold and/or displayed along with an entire collection sharing a common theme, according to embodiments of the present invention. According to embodiments of the present invention, the board may be dual-sided, such that the same or a different graphic design is applied to each of the two sides.

According to embodiments of the present invention, holes of different sizes and/or shapes may be included in the display board to accommodate decorative accessories of different size, kind, or shape. The grommets may be interchangeable with other grommets of a different kind, size, or shape, to accommodate decorative accessories of a different size, kind or shape. For example, a grommet with a larger hole size may be snapped into a hole in the board, then unsnapped from the board, and a grommet with a similar outer diameter but with a smaller hole may be snapped into the same hole in the board to accommodate a decorative accessory configured for insertion through a smaller hole.

Boards according to embodiments of the present invention may be used not only for collectors, but also for retailers displaying decorative accessories and/or sets of decorative accessories for sale. Based on the disclosure provided herein, one of ordinary skill in the art will recognize that the depicted grommet may be constructed of a variety of different materials in order to achieve an expandable and/or stretchable hole configured to receive a decorative accessory with a dimension larger than the expandable and/or stretchable hole. Based on the disclosure provided herein, one of ordinary skill in the art will also appreciate the variety of alternative ways that grommets may be incorporated into the board.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for securing a decorative accessory, comprising:
a display board comprising an upper surface, a lower surface, and at least one hole; and
at least one grommet configured to be inserted in said at least one hole and to receive a decorative accessory, said at least one grommet including a center portion, a grommet hole, and first and second ends, said first end configured to engage said upper surface of said display board upon insertion of said at least one grommet in said at least one hole, said second end configured to engage said lower surface of said display board upon insertion of said at least one grommet in said at least one hole, the grommet hole configured to receive said decorative accessory, said decorative accessory having at least one dimension larger than said grommet hole when said grommet hole is in an unexpanded state.

2. The system according to claim 1, wherein said center portion of said at least one grommet is further configured to engage an inner surface of said expandable hole upon insertion of said at least one grommet in said at least one hole.

3. The system according to claim 1, wherein
said at least one hole is preformed, and
said at least one grommet is further configured to snap into said at least one hole.

4. The system according to claim 1, wherein
the at least one hole is a plurality of holes, and
the at least one grommet is a plurality of grommets.

5. The system according to claim 4, wherein said plurality of holes is arranged in a predetermined pattern.

6. The system according claim 4, wherein a first hole of said plurality of holes has a first diameter smaller than a second diameter of a second hole of said plurality of holes.

7. The system according to claim 1, wherein said upper surface of said display board includes a graphical design indicative of a type of decorative accessory to be inserted in said at least one hole.

8. The system according to claim 1, wherein said lower surface of said display board includes a graphical design indicative of a type of decorative accessory to be inserted in said at least one hole.

9. The system according to claim 1, wherein said display board and said at least one grommet are composed of molded resin material.

10. The system according to claim 1, wherein said display board is composed of cardboard.

11. The system according to claim 1, wherein said display board is integrally formed with said at least one grommet.

12. A system for securing a decorative accessory, comprising:
a decorative accessory;
a display board comprising an upper surface, a lower surface, and at least one hole; and
at least one grommet configured to be inserted in said at least one hole and to receive said decorative accessory, said at least one grommet including a center portion, a grommet hole, and first and second ends, said first end configured to engage said upper surface of said display board upon insertion of said at least one grommet in said at least one hole, said second end configured to engage said lower surface of said display board upon insertion of said at least one grommet in said at least one hole, the at least one grommet configured to receive said decorative accessory, said decorative accessory having at least one dimension larger than said grommet hole when said grommet hole is in an unexpanded state.

13. A method for displaying at least one decorative accessory, said method comprising:
forming at least one hole in a display board, said display board including an upper surface and a lower surface; and
inserting at least one grommet into said at least one hole, said at least one grommet comprising a center portion, a grommet hole, and first and second ends, said first end configured to engage said upper surface of said display board, said second end configured to engage said lower surface of said display board.

14. The method of claim 13, further comprising:
inserting a decorative accessory through said grommet hole, said at least one decorative accessory having at least one dimension larger than a diameter of said grommet hole.

15. The method according to claim 13, wherein said at least one hole is pre-formed in said display board, and wherein inserting said at least one grommet into said at least one hole comprises snapping said at least one grommet into said at least one hole.

16. The method according to claim 13, wherein said at least one hole is a plurality of holes, and wherein said at least one grommet is a plurality of grommets.

17. The method according to claim 16, further comprising:
arranging said plurality of holes and said plurality of grommets into a predetermined pattern.

18. The method according to claim 13, further comprising:
printing on said upper surface of said display board graphical information indicative of a type of decorative accessory to be inserted through said at least one grommet.

19. The method according to claim 18, further comprising:
printing on said lower surface of said display board graphical information indicative of said type of decorative accessory to be inserted through said at least one grommet.

20. The method according to claim 13, wherein said display board is composed of a molded resin material.
